(19) United States
(12) Patent Application Publication
(10) Pub. No.: US 2005/0055638 A1
(43) Pub. Date: Mar. 10, 2005

(54) Customized book and method of manufacture

(76) Inventors: Leslie H. Lazareck, Las Vegas, NV (US); Sherry A. Fehrmann, Las Vegas, NV (US)

Correspondence Address: Morishita Law Firm, L.L.C.;Suite 102, 2725 S. Jones Blvd., Las Vegas, NV, 89146, US

(21) Appl. No.: 10/970,965

(22) Filed: Oct. 22, 2004

Related U.S. Application Data
(62) Division of application No. 10/765,298, filed on Jan. 26, 2004.
(60) Provisional application No. 60/446,056, filed on Feb. 7, 2003.

(51) Int. Cl. G06F 17/00

(52) U.S. Cl. 715/531

(57) ABSTRACT

A customized book includes fixed text and fixed illustrations combined with at least some customized text and at one customized illustration. Fixed text and fixed illustrations are selected. Customized text is generated using input customizing data and customized illustration is generated using input customizing image data. Composite text is generated by integrating customized text with fixed text. Composite text is combined with fixed illustrations and customized illustration, optionally integrated into composite illustrations, to form a customized book. The customized book is output and optionally combined with a customized cover.

### RELATED APPLICATION DATA

The present application is a divisional application of U.S. patent application Ser. No. 10/765,298, entitled “Customized Book and Method of Manufacture,” filed Jan. 26, 2004 by Applicants herein which, in turn, claimed the priority of U.S. Provisional Application Ser. No. 60/446,056, entitled “Customized Book and Method of Manufacture,” filed Feb. 7, 2003 by Applicants herein.

### FIELD OF THE INVENTION

The present invention is a customized book and a method of creating a customized book. More specifically, the present invention is a method of customizing text and illustrations in accordance with input to create a customized book.

### BACKGROUND OF THE INVENTION

It has long been desirable to create customized documents, specifically books, for a variety of purposes and users. For example, Kraynak et al., U.S. Pat. No. 3,892,427, discloses pre-printing non-variable copy with gaps therein. Customized copy is created and printed into the gaps in the pre-printed non-variable copy to create a customized text of a book. The drawback of this method is that the customized copy is limited to the size of the gaps in the pre-printed copy. Thus, customized copy that is too long or too short for the gap will not be aesthetically pleasing and could interfere with adjacent pre-printed copy. Also, such a system does not address customization of illustrations.

It is also known in the art to automatically merge data into a template using word processing technology to create a number of customized documents using the same format. One particular application of this technology is the creation of customized books. For example, Chanenson et al., U.S. Pat. No. 5,765,874, describes customizing comic books by merging variable text with fixed text to generate integrated text which is formatted and printed into pre-printed “balloons” in pre-printed illustrations.

There are drawbacks to this approach, as with other approaches that use pre-printed pages with illustrations already appearing thereon such as, for example, Kalisher, U.S. Pat. No. 5,213,461. First, registration of the text with the illustrations can be difficult and, more likely than not, many pages will include registration or alignment errors between the text and the pre-printed illustrations. This can result in a text that is difficult to read since it overlaps the illustrations.

Second, with pre-printed illustrations, there is no opportunity to customize the illustration to the customized text. This can be a significant omission if the customized book is intended for a child who is likely to be as interested, if not more interested, in the illustrations as the text.

One response to the inability to customize illustrations is shown in D'Andrea, U.S. Pat. No. 5,238,345, in which scanned photographs and customized text are superimposed into generic illustrations to create a customized book. For example, D'Andrea discloses utilizing a generic illustration of the body of a basketball player. The illustration is customized by superimposing a photograph of a subject's face into a gap where the basketball player's head would appear and printing a subject's name onto the basketball player's uniform.

Such a system has drawbacks of its own such as, again, registration errors in the superimposition of the images and the strange, distracting effect of superimposing a photograph of a face onto a body when the face and body clearly have incompatible shapes, sizes, and positioning. Moreover, such a system would require some amount of expertise in properly placing the photograph into the generic illustration and would, most likely, be beyond the skill of an ordinary consumer.

### SUMMARY OF THE INVENTION

The present invention is a customized book and method of creating and/or manufacturing a customized book. The customized book has fixed text combined with at least some customized text and at least one customized illustration. Optionally, the customized book also includes at least one fixed illustration.

The customized book is created by selecting a fixed text. Optionally, a number of different fixed texts are available. In a further optional embodiment, a number of fixed text components are available that can be separately selected to create a complete fixed text.

Customizing data is input at an input device and customized text is generated by a data processor based on the customizing data. The customized text is integrated into the selected fixed text to generate composite text consisting of both customized text and the selected fixed text.

At least one customized illustration is included in the customized book among the fixed illustrations. The customized illustration is created from customizing image data input by the user. Optionally, the customizing image data is image data such as a scanned photograph. A customized illustration is generated based on the customizing image data. The customized illustration is integrated into the customized book with the composite text. In an optional embodiment with fixed illustrations, the fixed illustrations and customized illustrations may be presented separately or the customized illustration is optionally integrated into or among fixed illustrations to create composite illustrations.

The customized illustration and composite text are output to an output device. Optionally, the illustrations and text are printed by a printer in pages. Optionally, the pages are printed on both sides of a page. Additionally or alternatively, the pages are printed in folios.

The pages are assembled. In an optional embodiment in which the pages are printed in folios, the printed folios are sorted and folded to form a signature.

The pages are bound. In an optional embodiment, the pages, optionally a signature of pages, are nested into an adhesive sheet with adhesive on a surface facing outward from the signature. The signature and adhesive sheet are secured to one another, such as through staples, stitching, adhesive, or other fastener, and a cover is secured to the adhesive sheet. Optionally, the cover is customized. This customization may take the form of adhering a customized label to all or a portion of the cover. If only a portion of the cover is covered by the label, a portion of the remainder of the cover may optionally be pre-printed. The cover may also be customized through a die-cut process.

### BRIEF DESCRIPTION OF THE DRAWINGS

FIG. 1 is a block diagram of a system utilized in implementing an embodiment of the method of the present invention;

FIG. 2 is a flowchart of a method according to an embodiment of the present invention;

FIG. 3 is a front view of a page of a customized book according to an embodiment of the present invention;

FIG. 4 is a front view of a cover of a customized book according to an embodiment of the present invention.

### DESCRIPTION

Reference is now made to the figures wherein like parts are referred to by like numerals throughout. The present invention relates to the customization of a text and related illustration and the creation of a customized book 60 using the customized text 62 and illustration. For the purposes of the description below, the term “user” refers to the one who provides the customizing data for the customized book 60 while the term “subject” refers to the one whom the customizing data regards. It is possible that the user and the subject could be the same. It is also possible that the user and the subject may be different. As an example, the subject of a customized book 60 could be a child, a pet, or any other person, place, thing, or event. While the examples below refer to a children's book, these examples should be considered illustrative and not limiting in scope.

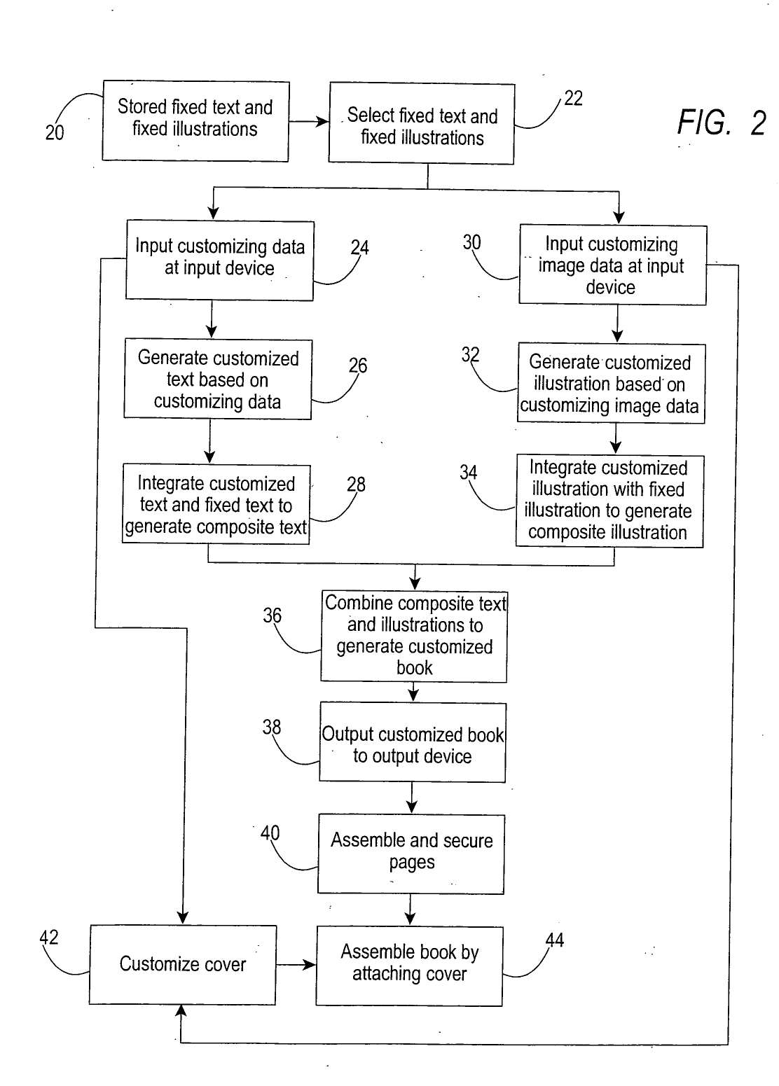

Referring first to FIG. 2, the present invention includes a method for manufacturing or creating a customized book 60. The method could be implemented in a number of different formats including software operating on a general purpose computer or software operating over a computer network such as the Internet. If the method is implemented in software operating on a general purpose computer, it is contemplated that the general purpose computer may belong to the user, may belong to a service provider communicating with the user such as by telephone or e-mail, or may be publicly available in a shop or kiosk.

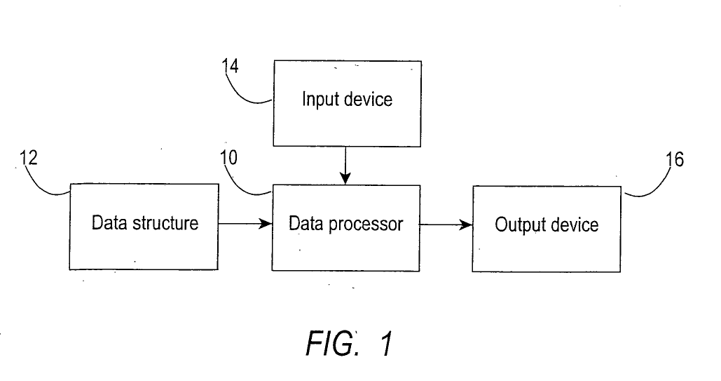

As shown in FIG. 1, regardless of the implementation, a data processor 10 communicates with a data structure 12 storing instructions for practicing the method and other fixed data, described in greater detail below. The data structure 12 could take any form including optical media, magnetic media, random access memory (“RAM”), read only memory (“ROM”), electrically programmable read only memory (“EPROM”), electrically alterable read only memory (“EAROM”), electrically erasable programmable read only memory (“EEPROM”), or any other memory device.

The data processor 10 receives input from a connected input device 14. The input device 14 could take any form including an image capture device, such as a camera or scanner, a data input device, such as a keyboard, mouse, or the like, a communications device for importing data from another data source, or any other device that could capture data for transmission to the data processor 10.

The data processor 10 outputs the results of the method to a connected output device 16. The output device 16 could take many formats including a data storage device, such as an optical or magnetic storage device for storing the output on optical or magnetic media, or a printer.

Returning to FIG. 2, among the fixed data stored 20 at the data structure 12 are one or more fixed texts 64, such as stories. In an optional embodiment including one or more fixed illustrations 54, the fixed illustrations are among the fixed data stored 20 at the data structure 12. In one optional embodiment, the user selects 22 a fixed text 64 from a plurality of fixed texts 64. In another optional embodiment, the fixed text 64 is formed by the user selecting fixed text components. In this manner, a user can direct the course of the story as well as customizing the story to the subject in a manner described below. In one example embodiment, the number of fixed text components available, m, could optionally be greater than the number of fixed text components, n, needed to form a fixed text 64 so that many different fixed texts 64 could be formed from the fixed text components. That is, the user would select n fixed text components from m available fixed text components where m>n.

In an optional embodiment, at least one fixed illustration 54 may be provided. In one embodiment, each fixed text 64 is linked with fixed illustrations 54 and, thus, when the user selects 22 a fixed text 64 or fixed text components making up the fixed text 64, the fixed illustration 54 or fixed illustrations 54 linked thereto are automatically selected for the user. Alternatively, fixed illustrations 54 and fixed text 64 are separately selected 22. In one such embodiment, a user selects 22 one or more fixed illustrations 54. Fixed illustrations 54 could take many different forms. For example, a background illustration or similar illustration that would not need to be changed as a book 60 is customized, could be a fixed illustration 54.

Customizing data regarding the subject is input 24 using the input device 14. As discussed above, the customizing data may be input 24 using a keyboard, mouse, scanner, camera, or other input device 14. As alluded to above, the customizing data may also be input by importing the customizing data from another data source in an optional embodiment in which the input device 14 is a communications device.

The customizing data may include any data. For example, customizing data may include names, places, things, activities, descriptions, or the like. From this customizing data, customized text 62 is generated 26. It should be noted that the customized text 62 need not necessarily have a one-to-one correlation with the customizing data but that the customizing data may be used repeatedly in generating 26 the customized text 62. For example, if the customizing data include a name, that name may be used repeatedly in the customized text 62.

Also, it is contemplated that in generating 26 the customized text 62, the customized text 62 may depend on the customizing data without necessarily representing verbatim the customizing data. As an example, if the customizing data include that the subject's gender is female, the data processor may selectively generate 26 customized text 62 using the pronoun “she” and the possessive pronoun “her” (as opposed to using the pronoun “he” and the possessive pronoun “his” when the customizing data indicate that the subject is male) by using the input gender data rather than requiring the user to input the pronoun and possessive pronoun for the female subject.

Customizing image data is input 30 at an input device 14. It should be noted that the customizing image data may be input 30 at the same or different input device 14 as the customizing data. For example, customizing data may be input 24 at a keyboard input device while customizing image data may be input 30 at a digital camera. Alternatively, for example, customizing data and customizing image data may both be input 24, 30 at a scanner.

Customizing image data is optionally represented by image data captured by the input device 14. For example, the customizing image data may be image data captured by a camera or acquired from a photograph scanned at a scanner. Regardless of how the customizing image data is acquired, the customizing image data is used to generate 32 at least one customized illustration 52. In an optional embodiment, the customized illustration 52 may be previewed and edited prior to output.

The customized illustration 52 could be generated 32 in a number of different ways. For example, the customizing image data may consist of a series of selections of stock features to generate 32 a customized illustration 52 incorporating the selected stock features. Such a system would be analogous to a paper doll where a framework is provided and the customizing image data are selections of certain features selected from a list of stock features that the data processor adds 10 to the framework.

Alternatively, the customizing image data may consist of digital image data. In such an embodiment, it is contemplated that the level of manipulation of the digital image could range greatly in generating 32 the customized illustration 52. For example, a minimum of manipulation could take place by merely cropping and sizing the customizing image data to produce the customized illustration 52.

In a further embodiment, the customizing image data is manipulated by the data processor 10 to create a caricature or cartoon of the subject in the customizing image data. That is, features of the customizing image data may be used to generate 32 a customized illustration 52 based on the customizing image data through manipulation of the customizing image data.

In a related embodiment, certain features of the customizing image data may be recognized by the data processor 10 and used in generating a customized illustration 52 based on the customizing image data but using stock shapes rather than data manipulation. For example, based on the customizing image data showing a subject with short hair, round face, and green eyes, the data processor 10 may select stock shapes representing the length of hair, shape of face, and color of eyes recognized from the customizing image data to generate 32 the customized illustration 52.

It should also be noted that the customizing data may be combined with the customizing image data to generate 32 a customized illustration 52. For example, if the customizing data includes data that the subject owns a brown dog, the customized illustration 52 may be generated 32 to include a brown dog.

The customized text 62 and fixed text 64 are integrated 28 into a composite text 50 by the data processor 10. Once again, the customized text 62 and fixed text 64 need not have a one-to-one relationship but customized text 62 may be repeated within the fixed text 64 in generating the composite text 50. Optionally, the composite text 50 may be reviewed and edited prior to output.

A customized book 60 is created by the data processor 10 combining 36 the composite text 50 with the customized illustration 52. In an optional embodiment, the customized book 60 also includes fixed illustrations 54. In a further optional embodiment, the customized illustration 52 and fixed illustrations 54 are integrated 34 to generate composite illustrations 56. For example, if the customized illustration 52 is a caricature of the subject, the caricature could be integrated 34 into fixed illustrations 54 of settings or backgrounds to create composite illustrations 56 appropriate to the composite text 50. In an alternate optional embodiment, the customized illustration 52 and fixed illustrations 54 may be handled separately. For example, fixed illustrations 54 could appear on certain pages while a customized illustration 52 appears on others.

The customized book 60 may optionally be available for review and editing prior to output. The customized book 60 is output 38 to an output device 16. As discussed above, the output device 16 could be a display, a data storage device, a printer, or the like. For example, if the user intends the customized book 60 to be read on a computer screen or e-book, the output 38 could be to a storage media at a data storage device.

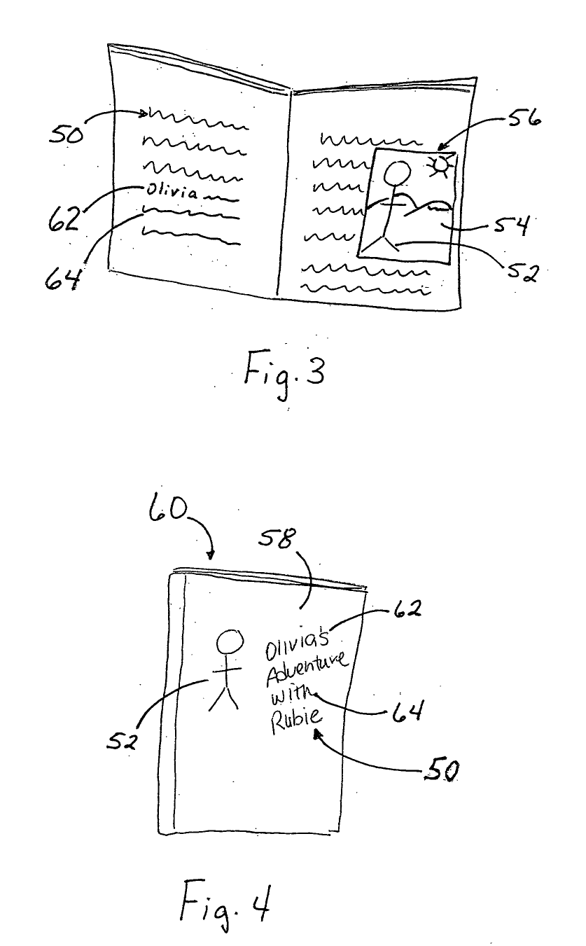

In another embodiment, the output device 16 is a printer. In such an embodiment, the customized book 60 may be output 38, as shown in FIGS. 3 and 4, and assembled in a variety of ways. The composite text 50 and customized illustration 52, as well as a fixed illustration 54 or composite illustration 56 in an optional embodiment including such features, are formatted into pages. The pages are printed at the printer on sheets of paper; optionally both sides of a sheet of paper are printed on. It also is contemplated that more than one page may be printed on each sheet of paper. That is, pages may be printed in folios of two or more pages on each side of a sheet of paper. In such an embodiment, the folios are then folded along page breaks. The pages, or folios as the case may be, are sorted and assembled in the desired order into signatures of pages. Depending on the number of pages, more than a single signature may be created.

A cover is also created. The cover may be customized 42, such as by printing or by adhering a customized label over a portion or all of the cover. The customized label could be generated using the same process as the customized book 60 itself by combining customized text 62 with fixed text 64 to generate composite text 50 alone or with customized illustration 52, fixed illustration 54, or composite illustration 56. In an embodiment in which an customized cover 58 on the adhesive label adheres over only a portion of the cover, the remainder of the cover may be pre-printed.

For example, a hard cover book may be created by adhering a hard cover to the adhesive sheet. A customized cover 58 is printed on an adhesive label and adhered to the hard cover to over a portion or all of the hard cover. Alternatively, a soft cover book may be created by printing directly onto the cover 58 material.

The customized book 60 may be bound in many different ways. In one optional embodiment, the signature or signatures are nested in an adhesive sheet with adhesive on a surface facing outward from the pages and the assembly is secured 40. Where fewer pages are present, staples may be used; where more pages are present, the customized book 60 may be bound using adhesive, stitching, or the like. In such an embodiment, a cover is attached 44 to the adhesive sheet.

In another optional embodiment, the book is bound using a crimp binding process. One optional crimp binding process is called CHANNELBIND® in which a machine crimps the pages together.

While certain embodiments of the present invention have been shown and described it is to be understood that the present invention is subject to many modifications and changes without departing from the spirit and scope of the claims presented herein.

1. A method of manufacturing a customized book comprising:
providing a data processor;
providing a data storage device in communicating with said data processor, said data storage device storing fixed text and at least one fixed illustration;
providing an input device communicating with said data processor;
providing an output device communicating with said data processor;
inputting customizing data at said input device;
said data processor generating customized text from said customizing data;
said data processor generating composite text by integrating said customized text into said fixed text;
said data processor receiving customizing image data;
said data processor generating a customized illustration from said customizing image; and
outputting at said output device said customized book comprising in combination said composite text, at least one fixed illustration, and at least one customized illustration.

2. The method of claim 1 further comprising said data processor generating at least one composite illustration from at least one customized illustration integrated into at least one fixed illustration.

3. The method of claim 1 further comprising selecting said fixed text from a plurality of fixed texts.

4. The method of claim 1 further comprising selecting n fixed text components selected from a plurality of m fixed text components, wherein m>n, to form said fixed text.

5. The method of claim 1 further comprising selecting said fixed illustration from a plurality of fixed illustrations.

6. The method of claim 1 wherein said step of receiving customizing image data comprises receiving selections of stock features.

7. The method of claim 1 wherein said step of receiving customizing image data comprises receiving digital image data.
